(19) United States
(12) Patent Application Publication
(10) Pub. No.: US 2025/0164608 A1
(43) Pub. Date: May 22, 2025

(54) LIDAR SYSTEM AND VEHICLE

(71) Applicant: AUTOX TECH PTE. LTD., SINGAPORE (SG)

(72) Inventors: Yizhou Shan, Shenzhen (CN); Jianxiong Xiao, Shenzhen (CN); Xuhui Tao, Shenzhen (CN); Tuo Cai, Shenzhen (CN); Dong Feng, Shenzhen (CN); Pingan Ding, Shenzhen (CN); Lele Yan, Shenzhen (CN)

(73) Assignee: AUTOX TECH PTE. LTD., SINGAPORE (SG)

(21) Appl. No.: 18/950,022

(22) Filed: Nov. 16, 2024

(30) Foreign Application Priority Data
Nov. 16, 2023 (CN) 2023115343060

(51) Int. Cl. G01S 7/48; G01S 7/481; G01S 7/497; G01S 17/931

(52) U.S. Cl. CPC G01S 7/4808; G01S 7/4811; G01S 7/4815; G01S 7/4816; G01S 7/497; G01S 17/931

(57) ABSTRACT

A LiDAR system is provided for providing target data to external devices. The LiDAR system includes a LiDAR device, a data processing device, and a power assembly. The LiDAR device includes a first LiDAR component that generates a first sensing signal, and a second LiDAR component that generates a second sensing signal; the data processing device includes a first data processor and a second data processor; the power assembly includes a first power component and a second power component. The LiDAR system incorporates two sets of photoelectric components (such the first and the second LiDAR components) and power supply components (such as the first and the second power components) that perform identical functions and operate simultaneously, ensuring the security and reliability of the LiDAR system data.

### CROSS SECTION

This non-provisional patent application claims priority under 35 U.S.C. § 119 from Chinese Patent Application No. 202311534306.0 filed on Nov. 16, 2023, the entire content of which is incorporated herein by reference.

### TECHNICAL FIELD

The disclosure relates to the field of LiDAR technology, particularly to a redundant architecture LiDAR system and vehicle.

### BACKGROUND

As a crucial technology in optical remote sensing, LiDARs have been extensively applied in practical production and daily life, and people's expectations for LiDAR performance are continually rising. How to ensure the effective transmission of LiDAR data has become an important issue. The existing LiDAR only establishes data redundancy mechanisms after acquiring LiDAR data to prevent the issue of LiDAR data loss. However, in LiDAR, the optoelectronic system and power supply system also experience failures. Therefore, establishing a data redundancy mechanisms for data transmission after copying LiDAR data still cannot guarantee the safety and reliability of LiDAR data.

### SUMMARY

In view of this, it is necessary to provide a LiDAR system and vehicle that effectively mitigates the risk of failure in the overall optoelectronic system and enhances the reliability of data transmission from the LiDAR to external devices.

Firstly, a LiDAR system for providing target data to external devices provided includes a LiDAR device, a data processing device, and a power component. The LiDAR device includes a first LiDAR component to generate a first sensing signal, and a second LiDAR component to generate a second sensing signal. The data processing device includes a first data processor, and a second data processor. The power assembly includes a first power component, and a second power component, the first power component is electrically connected to the LiDAR device and the data processing device respectively, and the second power component is electrically connected to the LiDAR device and the data processing device respectively; wherein when either the first power supply component or the second power supply component is working abnormally, or both the first power supply component and the second power supply component are working normally, the power supply component provides power to ensure normal operations of the LiDAR device and data processing device; wherein when either the first LiDAR component or the second LiDAR component is working abnormally, the data processing device receives and processes the first sensing signal or the second sensing signal to obtain first sensing data or second sensing data; when both the first and second LiDAR components are working normally, the data processing device receives and processes the first sensing signal and the second sensing signal to obtain the third sensing data; when either the first data processor or the second data processor is working abnormally, one of the first data processing device and the second data processor attempts to obtain and process the first sensing signal or the second sensing signal from the other of the first data processing device and the second data processor, to obtain the first sensing data, the second sensing data, or the third sensing data; the data processing device receives and processes the first sensing signal and the second sensing signal to obtain the third sensing data when both the first data processor and the second data processor are working normally; wherein the LiDAR system uses each of the first sensing data, second sensing data, and third sensing data to provide the target data to the external device.

Secondly, a vehicle provided includes a vehicle body, and least one aforementioned LiDAR system set on the vehicle body.

The above LiDAR system incorporates circuit redundancy in its LiDAR devices, data processing units, and power components. In the event that certain components fail or malfunction due to any reason, this redundancy ensures that other parts remain unaffected. Consequently, external devices can safely acquire target data, enabling redundant processing of LiDAR data, enhancing the reliability of data acquisition, and minimizing the risk of complete system failure.

### BRIEF DESCRIPTION OF THE DRAWINGS

In order to provide a clearer explanation of the embodiments of the disclosure or the technical solutions in the prior art, a brief introduction will be given below to the accompanying drawings required in the embodiments or prior art description. It is evident that the accompanying drawings in the following description are only some embodiments of the disclosure. For those skilled in the art, other accompanying drawings can be obtained based on the structures shown in these drawings without creative labor.

FIG. 1 illustrates a schematic diagram of the LiDAR system in accordance with an embodiment.

FIG. 2 illustrates a schematic diagram of a transceiver channel of a LiDAR device in accordance with an embodiment.

FIG. 3 illustrates a schematic diagram of data links of the LiDAR system in accordance with an embodiment.

FIG. 4 illustrates a schematic diagram of a power supply assembly in accordance with an embodiment.

FIG. 5 illustrates a schematic diagram of a vehicle in accordance with an embodiment.

The implementation, functional characteristics, and advantages of the disclosure will be further explained in conjunction with the embodiments, with reference to the accompanying drawings.

### DETAILED DESCRIPTION OF THE EMBODIMENTS

In order to make the purpose, technical solution, and advantages of the disclosure clearer and clearer, the following will provide further detailed explanations of the disclosure in conjunction with the accompanying drawings and embodiments. It should be understood that the specific embodiments described here are only intended to explain the disclosure and are not intended to limit the disclosure. Based on the embodiments in the disclosure, all other embodiments obtained by ordinary technicians in the art without creative labor fall within the scope of protection of the disclosure.

The terms “first”, “second”, “third”, “fourth”, etc. (if any) in the specification and claims of the disclosure, as well as the accompanying drawings, are used to distinguish similar planning objects and need not be used to describe a specific order or sequence. It should be understood that the data used in this way can be interchanged in appropriate cases, in other words, the described embodiments are implemented in order other than those illustrated or described here. In addition, the terms “including” and “having”, as well as any variations thereof, may also include other content, such as processes, methods, systems, products, or equipment that include a series of steps or units, not necessarily limited to those clearly listed, but may include other steps or units that are not clearly listed or inherent to these processes, methods, products, or equipment.

It should be noted that the descriptions related to “first”, “second”, etc. in the disclosure are only for descriptive purposes and cannot be understood as indicating or implying their relative importance or implying the quantity of the indicated technical features. Therefore, the features limited to “first” and “second” can explicitly or implicitly include one or more of these features. In addition, the technical solutions between various embodiments can be combined with each other, but must be based on what ordinary technicians in the art can achieve. When the combination of technical solutions is contradictory or impossible to achieve, it should be considered that the combination of such technical solutions does not exist and is not within the scope of protection required by the disclosure.

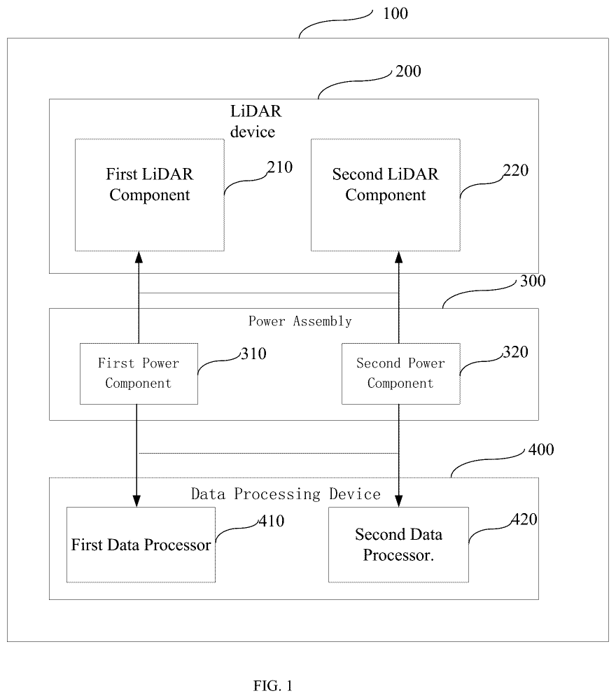

Referring to FIG. 1, a schematic diagram of a LiDAR system in an embodiment is illustrated. The LiDAR system establishes redundant mechanisms for optoelectronics, power supply, and data links to provide target data for external devices.

The LiDAR system 100 includes a LiDAR device 200, a power assembly 300, and a data processing device 400. The LiDAR device 200 includes a first LiDAR component 210, and a second LiDAR component 220, the first LiDAR component 210 generates a first sensing signal and the second LiDAR component 112 generates a second sensing signal.

The data processing device 400 includes a first data processor 410, and a second data processor 420.

The power component 300 includes a first power component 310, and a second power component 320. The first power component 310 is electrically connected to the first LiDAR component 210 and the first data processor 410, respectively. The second power component 320 is electrically connected to the first LiDAR component 210 and the first data processor 410, respectively. The first power component 310 is also electrically connected to the second LiDAR component 220 and the second data processor 420, respectively. The second power component 320 is also electrically connected to the second LiDAR component 220 and the second data processor 420, respectively.

When either the first LiDAR component 210 or the second LiDAR component 220 is working abnormally the data processing device 400 receives and processes the first sensing signal or the second sensing signal via the first data processor 410 and the second data processor 420, and processes the first sensing signal or the second sensing signal to obtain the first sensing data or the second sensing data. It can be understood that when the first LiDAR component 210 is working abnormally, the data processing device 400 will receive and process the second sensing signal to obtain the second sensing data using the second data processor 420. When the second LiDAR component 220 is working abnormally, the data processing device 400 will receive and process the first sensing signal to obtain the first sensing data using the first data processor 420. When both the first LiDAR component 210 and the second LiDAR component 220 are working normally, the data processing device 400 receives and processes the first sensing signal and the second sensing signal and processes to obtain third sensing data. Specifically, the processing of the first sensing signal and the second sensing signal involves enabling mutual data transmission between the first data processor 410 and the second data processor 420 data transmission to each other, merging and completing the first sensing signal and the second sensing signal to obtain the third sensing data, the third sensing data has undergone redundancy processing and processes integrity and reliability.

When one of the first data processor 410 and the second data processor 420 is working abnormal, the data processing device 400 sends the current data to the other one of the first data processor 410 and the second data processor 420, and enable the other one of the first data processor 410 and the second data processor 420 attempts to obtain the sensing signal from the one of the first data processor 410 and the second data processor 420, and then process the obtained sensing signal to obtain the first sensing data, the second sensing data, or the third sensing data. This way, it is possible to send the complete target sensing data to the external device as much as possible. For example, when the first data processor 410 is working abnormal, the second data processor 420 first attempts to obtain the first sensing signal from the first data processor 410, and receive the second sensing signal. It should be noted that if the attempt to obtain the first sensing signal fails, the second data processor 420 processes and obtains the second sensing data, if the attempt to obtain the first sensing signal is successful, the second data processor 420 will obtain and process the first sensing signal from the first and the second sensing data to obtain the third sensing data. For another example, when the second data processor 420 is working abnormal, the first data processor 410 first attempts to obtain the second sensing signal from the second data processor 420 and receive the first sensing signal. It should be noted that if the attempt to obtain the second sensing signal fails, the first data processor 410 will process and obtain the first sensing data; if the attempt to obtain the second sensing signal is successful, the first data processor 410 will process the first and obtain the third sensing data. When the first data processor 410 and the second data processor 420 are both working normally, the data processing device 400 will receive and process the first sensing signal and the second sensing signal to obtain the third sensing data.

The first sensing data, the second sensing data, and the third sensing data mentioned above can be used by the LiDAR system 100 to provide the target data to external devices, ensuring that even if there is a link failure outside the LiDAR (for example, one of the two network cables connected to the LiDAR fails), the maximum amount of target data can still be transmitted to external devices.

The LiDAR system 100 achieves independent transmission of single sensing data via redundancy mechanism featuring dual backup and circuit isolation in the aforementioned LiDAR device 200, the data processing device 400, and the power supply component 300, thereby ensuring that the entire LiDAR system 100 can continue to operate with limited functionality in the event of a short circuit or failure of a specific component, maintaining reliable transmission of sensing data.

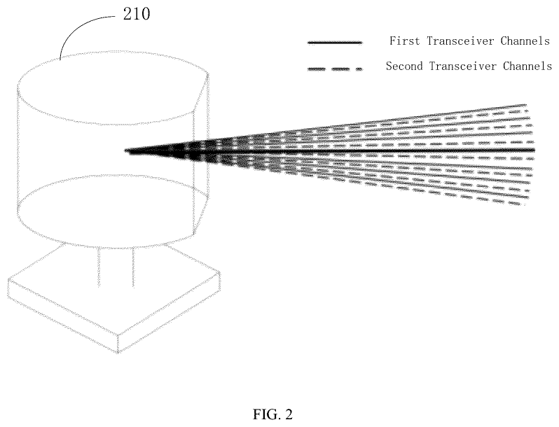

Referring to FIG. 2, a schematic diagram of a receiving and transmitting channel of the LiDAR device provided in accordance with an embodiment is illustrated.

LiDARs can be categorized into three types based on their scanning methods: mechanical rotary LiDARs, semi-solid (also known as hybrid solid) LiDARs, and all solid (also known as pure solid) LiDARs. In this embodiment, a mechanical rotating LiDAR is used as an illustrative example. It should be noted that the arrangement of the transmitting and receiving channels in the disclosure is not limited by the shape of the LiDAR, and is also applicable to semi-solid LiDAR and all solid LiDAR, without limitation.

The first LiDAR component 210 includes a plurality of first transceivers, the second LiDAR component 220 includes a plurality of second transceivers, the LiDAR system 100 has a predetermined field of view, the first transceivers include a plurality of first transceiver channels, the second transceivers include a plurality of second transceiver channels, and the first transceiver channels and the second transceiver channels are arranged within the predetermined field of view according to a predetermined longitudinal direction. Specifically, in a stationary state, the arrangement of the transceiver channels will be split into multiple columns and arranged horizontally due to space constraints and high diagonal resolution needs, Yet, the importance of lateral unfolding is often overlooked in discussions about LiDAR's longitudinal resolution. In actual design and production of the LiDARs, due to the large volume of the device, the adjacent longitudinal transceiver channels can only be dispersed into different columns based on the predetermined longitudinal direction to prevent a device from collision (or inability to arrange). There are no restrictions on the number of columns for horizontal expasion. Alternatively, the first and second transceiver channels may be arranged in a straight line in the longitudinal direction within the predetermined field of view.

In this embodiment, the vertical field of view of the LiDAR component is 20 degrees. Within this field of view, 100 transceiver channels are arranged at the same intervals. Therefore, one transceiver channel is divided every 0.2 degrees of field of view. The plurality of the first and second transceiver channels are arranged alternately, and can be crossed in the form of 1-3-5 . . . 99, 2-4-6 . . . 100. In another embodiment, the plurality of the first transceiver channels are arranged at the top or the bottom of the plurality of the second transceiver channels, which can be 1-50 as a group and 51-100 as a group. In another embodiment, several first and second transceiver channel clusters are arranged alternately, wherein each first transceiver channel cluster consists of 20 adjacent first transceiver channels; Each second receiving and transmitting channel cluster consists of 20 adjacent second transceiver channels, such as (1-20)+(21-40)+(41-60)+(61-80)+(81-100),these can be any single item or any combination of items. In this embodiment, the ratio is 20:20, or simply 1:1. For example, in this embodiment, the groups (1-20), (21-40), (41-70), and (71-100) have a ratio of 20:30, or 2:3. In some embodiments, the ratio may not necessarily be 1:1 or 2:3, but can be any other ratio, such as 2:5 or 3:7, which will not be further elaborated here.

In another embodiment, the plurality of the first transceivers 2101 and the plurality of the second transceivers 2201 are arranged in a straight line in the longitudinal direction. In this embodiment, the LiDAR component is longitudinally arranged with 100 transceivers, and the plurality of the first transceivers 2101 and the plurality of the second transceivers 2201 are alternately set, which can follow a cross-alternating pattern of 1-3-5 . . . 99, 2-4-6 . . . 100. In another embodiment, the plurality of the first transceivers 2101 are positioned either above or below the plurality of second transceivers 2201, with the first transceivers 2101 forming one group 1-50 and the second transceivers 2101 forming another group 51-100. In another embodiment, a plurality of the first transceiver groups and a pluarlity of second transceiver groups are alternately arranged, wherein each transceiver group consists of composed of 20 adjacent first transceiver components 2101; each second transceiver group consists of 20 adjacent second transceiver components 2201, an alternating arrangement of transceiver groups, where each group consists of 20 consecutive transceiver components, starting with either a group of first transceiver components (e.g., 1-20) or second transceiver components (e.g., 21-40), and continuing this pattern until all 100 components are grouped (e.g., resulting in five groups if there are 100 components total). In this embodiment, In this embodiment, the ratio of first to second transceiver components may be 1:1 (e.g., 20:20). However, in some cases, different ratios such as 2:3, 2:5, or 3:7 may be used. The exact ratio will depend on the specific configuration and requirements of the system.

On each LiDAR component, dual data backup can be achieved through the transceiver and/or the transceiver's transceiver channels. By exchanging and completing information, as much information as possible is obtained for subsequent transmission to external devices. In even that on group of the transceiver channels fails for any reasons, such as power failure, short circuit, component malfunction, or physical damage—the corresponding field of view covered by the other set of transmitting and receiving channels can be preserved. Similarly, if one set of transceivers fails for any of these reasons, the corresponding field of view of the other set of transceivers remains unaffected. Complete circuit isolation ensures that the failure of one group does not impact the other.

The following will provide a detailed description of the data link transmission process for sensing data:

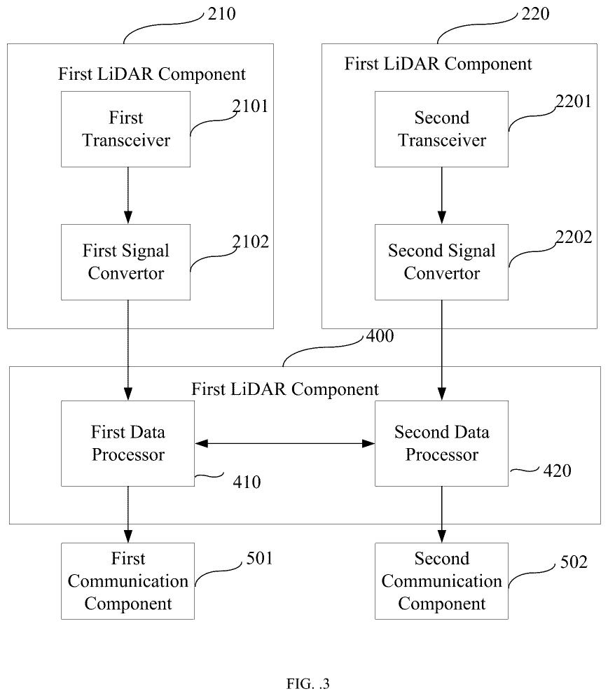

Referring to FIG. 3, a schematic diagram of the data link of the LiDAR system in accordance either an embodiment is illustrated.

In this embodiment, the first LiDAR component 210 further includes a first signal converter 2102 for converting optical signals into digital signals; When the first LiDAR component 210 is working, the first transceiver 2101 emits the first optical signal and receives the first echo signal through reflection, which is then transmitted to the first signal converter 2102 for signal conversion to obtain the first sensing signal. The second LiDAR component 220 further includes a second signal converter 2202 for converting optical signals into digital signals; When the second LiDAR component 220 is working, the second transceiver 2201 emits a second optical signal and receives the second echo signal through reflection, which is then transmitted to the second signal converter 2202 for signal conversion to obtain the second sensing signal.

When both the first data processor 410 and the second data processor 420 are working normally, the first data processor 410 receives the first sensing signal and processes it to obtain the first sensing data. The second data processor 420 receives the second sensing signal and processes it to obtain the second sensing data. The first data processor 410 sends the first sensing data to the second data processor 420, and the second data processor 420 sends the second sensing data to the first data processor 410. The first sensing data and the second sensing data are merged and completed to output the third sensing data. At this time, the third sensing data is the complete data after redundancy processing.

In this embodiment, the LiDAR system 100 further includes a first communication component 501 and a second communication component 502. The first communication component 501 and the second communication component 502 respectively send the sensing data generated by the first data processor 410 and the second data processor 420 to external devices. Specifically, the first communication component 501 receives sensing data transmitted by the first data processor 410 as either the first sensing data or the third sensing data. When the first LiDAR component 210 malfunctions, the first data processor 410 transmits the second sensing data sent by the second data processor 420 to the first communication component 501. Correspondingly, the second communication component 502 receives the sensing data transmitted by the second data processor 420 as either the second sensing data or the third sensing data. When the second LiDAR component 220 malfunctions, the second data processor 420 transmits the first sensing data sent by the first data processor 410 to the second communication component 501.

When the first communication component 501 malfunctions, the second communication component 502 is not affected and still operates normally to transmit sensing data to the outside. Similarly, when the second communication component 502 malfunctions, the first communication component 501 remains unaffected and still operates normally to transmit sensing data to the outside world. At this time, any one of the first sensing data, second sensing data, or third sensing data transmitted can be used to push target data to external devices by the LiDAR system 100. The use of backup data transmission methods outside the LiDAR ensures the integrity and effectiveness of data, avoiding the problem of data interruption and loss caused by external LiDAR reasons.

The first LiDAR component 210, the first data processor 410, and the first communication component 501 form the first data link, while the second LiDAR component 220, the second data processor 420, and the second communication component 502 form the second data link. The first and second data links only merge and forward the completely independent two sensing data channels inside the data processing device 400, and then the communication component sends out two sets of completely independent complete data. In the event of data loss occurring at any location, it can be ensured that the LiDAR system 100 will still has some or all of the data output. If any data link fails, there is another data link available to ensure the continued data transmission of the entire LiDAR system. It should be understood that currently the two sets of data link only need to be forwarded and merged once. In alternative embodiments, the three sets of data links can also be forwarded and merged three times, without specific limitations.

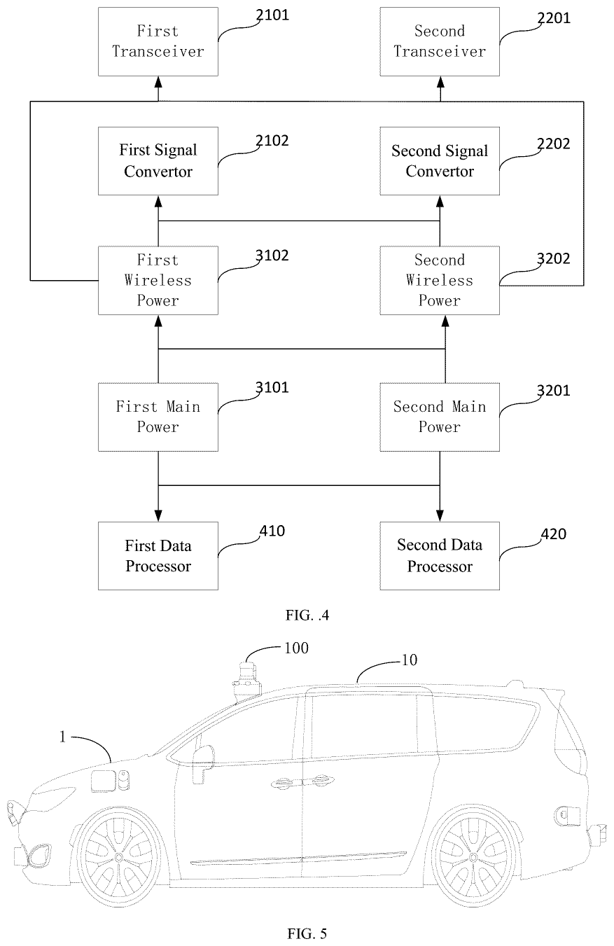

Referring to FIG. 4, a schematic diagram of the power supply component in accordance with an embodiment is illustrated.

The first power component 310 includes a first main power supply 3101, and a first wireless power supply 3102, and the second power component 320 includes a second main power supply 3201, and a second wireless power supply 3202. It should be noted that with the changes in the form of LiDAR products, in some feasible embodiments, the power component can be either wireless or wired, and will not be repeated here.

The first main power supply 3101 is electrically connected to the first data processor 410 and the second data processor 420; The second main power supply 3201 is electrically connected to both the first data processor 410 and the second data processor 420. The first wireless power supply 3102 is electrically connected to both the first LiDAR component 210 and the second LiDAR component 220, while the second wireless power supply 3202 is electrically connected to both the first LiDAR component 210 and the second LiDAR component 220. In addition, the wireless power supply mentioned above is powered by the main power supply mentioned above. The first main power supply 3101 is also electrically connected to both the first wireless power supply 3102 and the second wireless power supply 3202; The second main power supply 3201 is also electrically connected to both the first wireless power supply 3102 and the second wireless power supply 3202.

When both the first power supply component 310 and the second power supply component 320 are working normally, the first main power supply 3101 and the second main power supply 3201 jointly provide normal power consumption for the LiDAR system 100. When either the first power component 310 or the second power component 320 works abnormally, either the first power component 310 or the second power component 320 provides normal electrical power for the LiDAR device 200 and the data processing device 400. It can be understood that when the first power component 310 malfunctions, the power driving capacity of the second power component 320 will double, providing normal power for the LiDAR device 200 and data processing device 400 to ensure sufficient power supply for the entire LiDAR system 100. When the second power component 320 malfunctions, the first power component 310 provides normal electrical power for the LiDAR device 200 and the data processing device 400. When both the first power component 310 and the second power component 320 are working properly, the first power component 310 and the second power component 320 respectively provide the same power, and the value of the power is half of the value of the power consumption. It should be noted that the first power component and the second power component each have a capability greater than supplying power to the entire LiDAR system. For example, if the power supply required for the entire LiDAR system 100 is 100 W, then both the first power component 310 and the second power component 320 have at least 100 W of power supply capacity, which means that the entire power component 300 will have at least 200 W of power supply capacity. The first LiDAR component 210 and the first data processor 410 form the first set of power supply paths, while the second LiDAR component 220 and the second data processor 420 form the second set of power supply paths. When the electrical devices on both sets of power supply paths are working properly, each set of paths requires 50 W of power support. Specifically, all electrical equipment includes a LiDAR device 200 and a data processing device 400. Therefore, both power supplies only require 50 W output, and at this time, the first power component 310 and the second power component 320 both output half of their respective power supply capabilities. In this embodiment, the respective power supply capabilities are referred to as rated power. It can be understood that the actual power supply capacity of the first power component 310 and the second power component 320 differs from the rated power supply capacity due to differences in the components used in production and losses during use. That is to say, the output power can fluctuate according to the actual situation, for example, the output power fluctuates up and down at half of the rated power, and the fluctuation does not exceed 10%.

When one of the power components fails, the other power component serves as a backup power supply to bear all the power needs of the entire LiDAR system 100. At this time, the power component will fully provide 100 W of power support, and at the same time, provide 50 W of power support for each of the two power supply paths. In addition, when the power supply required for the entire LiDAR system 100 is 100 W, in order to leave some redundancy, the main power supply will be designed based on a power supply capacity greater than 100 W.

In this embodiment, the LiDAR system 100 further includes a wireless communication module (not shown) for achieving high-speed, stable, and long-distance data transmission. Specifically, taking the mechanical rotary LiDAR as an example, both the wireless power supply component and the wireless communication module are set on the rotation axis of the mechanical rotary LiDAR. In other embodiments, they can also be set at other positions of the LiDAR, which will not be listed one by one here. The wireless communication module includes a first wireless communication component and a second wireless communication component. The first wireless communication component is electrically connected to the first LiDAR component 210 and the first data processor 410; The second wireless communication component is electrically connected to the second LiDAR component 220 and the second data processor 420. With the changes in the form of LiDAR products, in some embodiments, the communication module can also be wired, which will not be repeated here.

Referring to FIG. 5, which is a schematic diagram of a vehicle provided in an embodiment of the disclosure.

The vehicle 1 includes the vehicle body 10 and a LiDAR system 100 installed on the vehicle body 10. In this embodiment, the LiDAR system 100 is located in the middle position of the roof of the vehicle body 10. In some feasible embodiments, the position of the LiDAR system 100 set on the vehicle body 10 is not limited to this. Specifically, one LiDAR system 100 is located in the middle position of the front of the vehicle body 10, and one LiDAR system 100 is located in the middle position of the rear of the vehicle body 10. Two LiDAR systems 100 can also be symmetrically located in the middle position on both sides of the vehicle body 10. In some feasible embodiments, the number of LiDAR systems 100 is not limited to this. Specifically, LiDAR systems 100 can be installed in various places around the front, back, and left of vehicle 10, or the number of installations can be set according to the size of vehicle 1. For example, multiple LiDAR systems 100 can be installed on large vehicles such as buses and trucks, and the installation height can be set according to the size of vehicle 1, without any limitations.

In the above implementation example, redundancy design was carried out for each of the LiDAR device 200, data processing device 400, and power component 300 in the LiDAR system 100, greatly reducing the probability of complete failure of the entire LiDAR system 100. Specifically, the LiDAR device 200 includes a first LiDAR component and a second LiDAR component that can independently complete the optoelectronic tasks of the LiDAR system 100, implementing a redundancy mechanism at the optoelectronic system layer; the data processing device 400 includes a first data processor and a second data processor that can independently complete data processing tasks, implementing a redundancy mechanism in the data link control layer; The power component 300 includes a first power component and a second power component that can independently provide power to the LiDAR system 100, achieving a redundant mechanism in the power layer. That is to say, regardless of the failure of any component in the LiDAR system 100, other components can work normally without being affected. On the one hand, each component in the LiDAR optoelectronic system layer works independently, ensuring the reliability of sensing data acquisition; On the other hand, utilizing the redundancy of the power layer ensures that any power input can supply power to all electrical equipment; On the other hand, in the data transmission link layer, only the minimum interaction part is retained to reduce coupling and prevent the other party from being affected in case of problems, thereby ensuring the reliability of the entire LiDAR system 100 in pushing target data to external devices, effectively solving the problem of machine failure caused by a single point of failure. In addition, through the dual backup of communication components, the problem of data interruption caused by external factors of the LiDAR is avoided.

Obviously, technicians in this field can make various modifications and variations to the disclosure without departing from the spirit and scope of the disclosure. In this way, if these modifications and variations of the disclosure fall within the scope of the claims and their equivalent technologies, the disclosure is also intended to include these modifications and variations.

The above listed examples are only the preferred embodiments of the disclosure, and of course, they cannot be used to limit the scope of the disclosure. Therefore, the equivalent changes made according to the claims of the disclosure still fall within the scope of the disclosure.

1. A LiDAR system for providing target data to external devices, the LiDAR system comprising:
a LiDAR device, including a first LiDAR component to generate a first sensing signal, and a second LiDAR component to generate a second sensing signal;
a data processing device, including a first data processor, and a second data processor; and
a power assembly, including a first power component, and a second power component, the first power component being electrically connected to the LiDAR device and the data processing device respectively, and the second power component being electrically connected to the LiDAR device and the data processing device respectively;
wherein when either the first power supply component or the second power supply component is working abnormally, or both the first power supply component and the second power supply component are working normally, the power supply component provides power to ensure normal operations of the LiDAR device and data processing device;
wherein when either the first LiDAR component or the second LiDAR component is working abnormally, the data processing device receives and processes the first sensing signal or the second sensing signal to obtain first sensing data or second sensing data; when both the first and second LiDAR components are working normally, the data processing device receives and processes the first sensing signal and the second sensing signal to obtain the third sensing data;
when either the first data processor or the second data processor is working abnormally, one of the first data processing device and the second data processor attempts to obtain and process the first sensing signal or the second sensing signal from the other of the first data processing device and the second data processor, to obtain the first sensing data, the second sensing data, or the third sensing data; the data processing device receives and processes the first sensing signal and the second sensing signal to obtain the third sensing data when both the first data processor and the second data processor are working normally;
wherein the LiDAR system uses each of the first sensing data, second sensing data, and third sensing data to provide the target data to the external device.

2. The LiDAR system of claim 1, wherein the first LiDAR component comprises a plurality of first transceivers, the second LiDAR component comprises a plurality of second transceivers, the LiDAR system has a predetermined field of view (FOV), the first transceivers include a plurality of first transceiver channels, the second transceiver includes a plurality of second transceiver channels, and the first transceiver channels and the second transceiver channels are arranged in a predetermined longitudinal angle distribution within the predetermined field of view.

3. The LiDAR system of claim 2, wherein the first transceiver channels and second transceiver channels are arranged alternately, or the first transceiver channels and second transceiver channels are arranged above or below the second transceiver channels, or first transceiver channel clusters and second transceiver channel clusters are arranged alternately, each first transceiver channel cluster consists of multiple adjacent first transceiver channels; each second transceiver channel cluster consists of multiple adjacent second transceiver channels.

4. The LiDAR system of claim 2, wherein the plurality of the first transceivers and the plurality of the second transceivers are arranged in a straight line in the longitudinal direction, the plurality of the first transceivers and the plurality of the second transceivers are alternately arranged, or if the first transceivers are located at the upper or lower part of the second transceivers, or if the first transceivers and the second transceivers are alternately arranged, wherein each transceiver group consists of several adjacent first transceiver components; each second transceiver group consists of several adjacent second transceiver components.

5. The LiDAR system of claim 1, wherein the first power component is electrically connected to both the first data processor and second data processor, and the second power component is electrically connected to both the first data processor and second data processor; the first power component is also electrically connected to both the first LiDAR component and second LiDAR component, and the second power component is also electrically connected to both the first LiDAR component and second LiDAR component.

6. The LiDAR system of claim 5, wherein the first power component comprises a first main power supply and a first wireless power supply, the second power component comprises a second main power supply and a second wireless power supply, and the first main power supply is electrically connected to both the first data processor and the second data processor; the second main power supply is electrically connected to both the first data processor and the second data processor; the first wireless power supply is electrically connected to both the first LiDAR component and the second LiDAR component, and the second wireless power supply is electrically connected to both the first LiDAR component and the second LiDAR component.

7. The LiDAR system of claim 6, wherein when both the first power supply component and the second power supply component are working normally, the first and second main power supplies together provide power for normal operations of the LiDAR devices and the data processing devices; when either the first power component or the second power component works abnormally, the other of the first power component and the second power component provides power consumption for the LiDAR device and the data processing device.

8. The LiDAR system of claim 7, wherein when both the first power component and the second power component are working normally, the first power component and the second power component respectively provide the same power, and the value of the power is half of the value of the power consumption.

9. The LiDAR system of claim 1, wherein the first LiDAR component further comprises a first signal converter, and the second LiDAR component further comprises a second signal converter, the first signal converter and the second signal converter are respectively connected to the first data processor and the second data processor in corresponding communication, and the first sensing signal and the second sensing signal are respectively sent to the first data processor and the second data processor, each of the first data processor and the second processor communicate to receive the first sensing signal or send the second sensing signal to the other.

10. The LiDAR system of claim 1, wherein the LiDAR system further comprises a first communication component and a second communication component, the first communication component and the second communication component respectively transmit the sensing data generated by the first data processor and the second data processor to external devices for providing the target data to the external devices.

11. A vehicle, the vehicle, comprising:
a body, and
at least one LiDAR system, providing target data to external devices, the LiDAR system comprising:
a LiDAR device, including a first LiDAR component to generate a first sensing signal, and a second LiDAR component to generate a second sensing signal;
a data processing device, including a first data processor, and a second data processor; and
a power assembly, including a first power component, and a second power component, the first power component being electrically connected to the LiDAR device and the data processing device respectively, and the second power component being electrically connected to the LiDAR device and the data processing device respectively;
wherein when either the first power supply component or the second power supply component is working abnormally, or both the first power supply component and the second power supply component are working normally, the power supply component provides power to ensure normal operations of the LiDAR device and data processing device;
wherein when either the first LiDAR component or the second LiDAR component is working abnormally, the data processing device receives and processes the first sensing signal or the second sensing signal to obtain first sensing data or second sensing data; when both the first and second LiDAR components are working normally, the data processing device receives and processes the first sensing signal and the second sensing signal to obtain the third sensing data;
when either the first data processor or the second data processor is working abnormally, one of the first data processing device and the second data processor attempts to obtain and process the first sensing signal or the second sensing signal from the other of the first data processing device and the second data processor, to obtain the first sensing data, the second sensing data, or the third sensing data; the data processing device receives and processes the first sensing signal and the second sensing signal to obtain the third sensing data when both the first data processor and the second data processor are working normally;
wherein the LiDAR system uses each of the first sensing data, second sensing data, and third sensing data to provide the target data to the external device.

12. The vehicle of claim 11, wherein the first LiDAR component comprises a plurality of first transceivers, the second LiDAR component comprises a plurality of second transceivers, the LiDAR system has a predetermined field of view (FOV), the first transceivers include a plurality of first transceiver channels, the second transceiver includes a plurality of second transceiver channels, and the first transceiver channels and the second transceiver channels are arranged in a predetermined longitudinal angle distribution within the predetermined field of view.

13. The vehicle of claim 12, wherein the first transceiver channels and second transceiver channels are arranged alternately, or the first transceiver channels and second transceiver channels are arranged above or below the second transceiver channels, or first transceiver channel clusters and second transceiver channel clusters are arranged alternately, each first transceiver channel cluster consists of multiple adjacent first transceiver channels; each second transceiver channel cluster consists of multiple adjacent second transceiver channels.

14. The vehicle of claim 12, wherein the plurality of the first transceivers and the plurality of the second transceivers are arranged in a straight line in the longitudinal direction, the plurality of the first transceivers and the plurality of the second transceivers are alternately arranged, or if the first transceivers are located at the upper or lower part of the second transceivers, or if the first transceivers and the second transceivers are alternately arranged, wherein each transceiver group consists of several adjacent first transceiver components; each second transceiver group consists of several adjacent second transceiver components.

15. The vehicle of claim 11, wherein the first power component is electrically connected to both the first data processor and second data processor, and the second power component is electrically connected to both the first data processor and second data processor; the first power component is also electrically connected to both the first LiDAR component and second LiDAR component, and the second power component is also electrically connected to both the first LiDAR component and second LiDAR component.

16. The vehicle of claim 15, wherein the first power component comprises a first main power supply and a first wireless power supply, the second power component comprises a second main power supply and a second wireless power supply, and the first main power supply is electrically connected to both the first data processor and the second data processor; the second main power supply is electrically connected to both the first data processor and the second data processor; the first wireless power supply is electrically connected to both the first LiDAR component and the second LiDAR component, and the second wireless power supply is electrically connected to both the first LiDAR component and the second LiDAR component.

17. The vehicle of claim 16, wherein when both the first power supply component and the second power supply component are working normally, the first and second main power supplies together provide power for normal operations of the LiDAR devices and the data processing devices; when either the first power component or the second power component works abnormally, the other of the first power component and the second power component provides power consumption for the LiDAR device and the data processing device.

18. The vehicle of claim 17, wherein when both the first power component and the second power component are working normally, the first power component and the second power component respectively provide the same power, and the value of the power is half of the value of the power consumption.

19. The vehicle of claim 11, wherein the first LiDAR component further comprises a first signal converter, and the second LiDAR component further comprises a second signal converter, the first signal converter and the second signal converter are respectively connected to the first data processor and the second data processor in corresponding communication, and the first sensing signal and the second sensing signal are respectively sent to the first data processor and the second data processor, each of the first data processor and the second processor communicate to receive the first sensing signal or send the second sensing signal to the other.

20. The vehicle of claim 11, wherein the LiDAR system further comprises a first communication component and a second communication component, the first communication component and the second communication component respectively transmit the sensing data generated by the first data processor and the second data processor to external devices for providing the target data to the external devices.
